(19) United States
(12) Patent Application Publication
(10) Pub. No.: US 2026/0043426 A1
(43) Pub. Date: Feb. 12, 2026

(54) COUPLING STRUCTURE FOR BOARD ASSEMBLY

(71) Applicant: YIXIANG BLOW MOLDING FURNITURE CO., LTD., Yuyao (CN)

(72) Inventor: Jinglei Jiang, Yuyao (CN)

(73) Assignee: YIXIANG BLOW MOLDING FURNITURE CO., LTD., Yuyao (CN)

(21) Appl. No.: 19/363,501

(22) Filed: Oct. 20, 2025

Related U.S. Application Data
(63) Continuation of application No. 17/553,424, filed on Dec. 16, 2021, now abandoned.

(30) Foreign Application Priority Data
Oct. 20, 2021 (CN) CN202111219616.4

(51) Int. Cl. F16B 5/00

(52) U.S. Cl. CPC F16B 5/0052; F16B 2200/30

(57) ABSTRACT

The present subject matter discloses a board coupling structure with a first board and a second board. The first board and the second board are respectively formed with strip-shaped ribs and strip-shaped grooves that can be interlocked with each other. The first board and the second board can only move relative to each other in the inserting direction. The strip-shaped rib has a constricted portion and a clamping portion. The advantage of the present subject matter is that the contact surface and biting degree of the connected boards are larger. The coupling structure is stable with improved waterproofing of the connection. Moreover, the boards do not need to be connected by connectors during assembling, which renders a fast and convenient assembly.

### CROSS-REFERENCES TO RELATED APPLICATIONS

This application is a continuation application of a U.S. patent application Ser. No. 17/553,424, entitled “COUPLING STRUCTURE FOR BOARD ASSEMBLY”, filed on Dec. 16, 2021, which claims the priority of CN Patent Application No. CN202111219616.4, entitled “COUPLING STRUCTURE FOR BOARD ASSEMBLY,” filed Oct. 20, 2021, which is incorporated herein by reference for all purposes.

### TECHNICAL FIELD

The present subject matter is in the field of board construction. More particularly, embodiments of the present subject matter relate to a screw-free, plug-in connection structure for plastic boards.

### BACKGROUND

Many of the existing furniture are constructed by assembling multiple boards. In the assembly process of these furniture, screws are often required to connect and fix the boards, which is troublesome to install. For example, take the cabinet structure as an example: when assembling the cabinet, people often need to use a screw driver to install and fix the screws and other connectors on the bottom board, four side boards and cover board, so that the bottom board, side board and cover board can be put together. The process is not only time-consuming and laborious but also has low efficiency.

In addition, when disassembling the cabinet, the screws must be removed one by one, which is also inconvenient. Moreover, when screws are needed, it is often necessary to reserve mounting holes on the boards when manufacturing them. For precise assembly, the position of these reserved mounting holes must be accurate. Otherwise, it would cause installation failure.

Even more, some cabinets are equipped with embedded connectors in the reserved mounting holes. These embedded parts are often manually installed, resulting in low efficiency. Although the prior art has disclosed the plug-in structure with improved efficiency, the bite of these plug-in structures is low, and the structural reliability and stability need to be further improved. In addition, the contact area of the joint is not large enough, resulting in poor waterproof ability. In summary, the existing board connection structure needs to be further improved.

### SUMMARY OF THE INVENTION

The present subject matter can solve the technical problem as described herein by providing a board coupling structure with a reliable structure and optimized stability in view of the present state of the art.

The technical solution of the present subject matter to solve the afore-mentioned technical problems is: a board coupling structure that comprises a first board and a second board each being respectively formed with a strip-shaped rib and a strip-shaped groove that can be inserted into each other, the first board and the second board being only movable relative to each other in the insertion direction, wherein the strip-shaped rib further comprises a constricted portion formed by a circumferential side of the first board and a clamping portion that extends from the constricted portion, and wherein the strip-shaped groove is provided in the inner side wall of the second board, and the shape of the strip-shaped groove matches the shape of the strip-shaped rib.

In order to enable the first board and the second board to be inserted in place, one end of the strip-shaped groove is formed with an opening, and the other end is closed.

According to some embodiments, the strip-shaped groove is disposed near an edge of the second board and is disposed along the length direction of the edge. As such, the first board and the second board can enable the mutual coupling and connection of the corresponding sides

According to some embodiments, the first board and the second board are perpendicular to each other when they are coupled. As such, the above-mentioned screwless, plug-in coupling structure can be used between two adjacent boards of a rectangular box.

According to some embodiments, the constricted portion and the circumferential side are perpendicular to each other, and the inner surface of the clamping portion and the constricted portion are perpendicular to each other.

According to some embodiments, the clamping portion further comprises a tapered head that is substantially pointed or flat.

According to some embodiments, the cross-section of the clamping portion is triangular.

According to some embodiments, the outer surface of the clamping portion is an arc surface.

According to some embodiments, the outer surface of the clamping portion is a concave-convex surface.

According to some embodiments, the concave-convex surface has a structure with convex on both sides and a concave in the middle or a structure with convex in the middle and concave on both sides.

Compared with the prior art, the present subject matter has the following advantages: the plug-in coupling structure of the two boards can adopt an insertion structure with a strip-shaped rib and a strip-shaped groove, and the strip-shaped rib comprises a constricted part and a clamping part. The clamping part gradually becomes smaller from the inside to the outside. As such, the contact surface of the rib and the groove is larger, which leads to larger biting degree and more stabilized structure. Furthermore, the coupled boards can be waterproof, and they do not need connectors during assembly. The assembly is convenient and fast. In addition, the board coupling structure has a wide range of applications, especially for the connection between two adjacent sideboards of the cabinet.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings and in which:

FIG. 1 is a schematic structural diagram of Embodiment I the present subject matter;

FIG. 2 is an enlarged schematic diagram of part A in FIG. 1;

FIG. 3 is an exploded schematic diagram of Embodiment I of the present subject matter;

FIG. 4 is an enlarged schematic diagram of part B in FIG. 3;

FIG. 5 is an enlarged schematic diagram of part C in FIG. 3;

FIG. 6 is a schematic structural diagram of Embodiment I of the present subject matter;

FIG. 7 is an enlarged schematic diagram of part D in FIG. 6;

FIG. 8 is a schematic structural diagram of Embodiment II of the present subject matter;

FIG. 9 is an enlarged schematic diagram of part E in FIG. 8;

FIG. 10 is a schematic structural diagram of Embodiment III of the present subject matter;

FIG. 11 is an exploded schematic diagram of Embodiment III of the present subject matter;

FIG. 12 is a schematic structural diagram of Embodiment IV of the present subject matter;

FIG. 13 is a schematic structural diagram of Embodiment IV of the present subject matter; and

FIG. 14 is a schematic structural diagram of Embodiment IV of the present subject matter.

### DETAILED DESCRIPTION

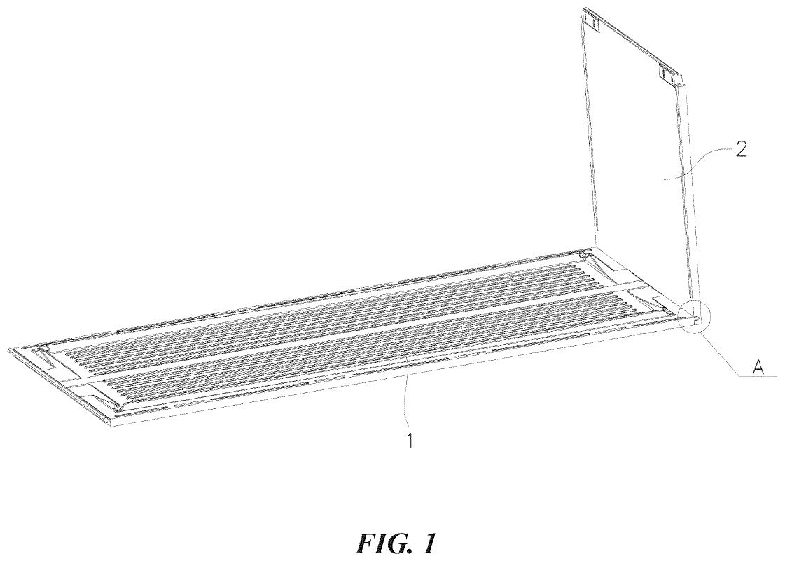

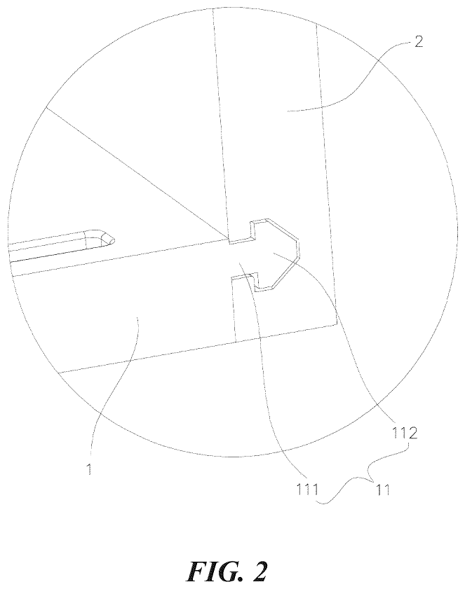

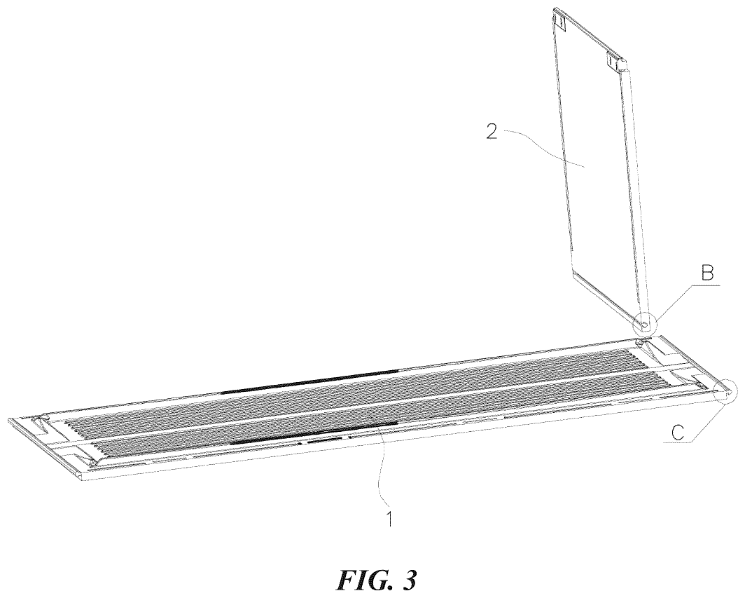

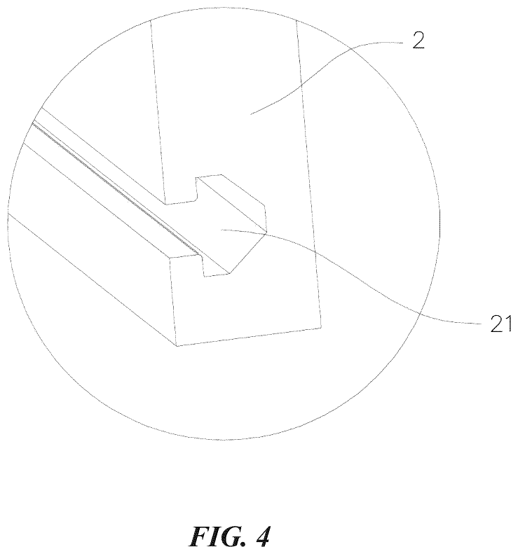

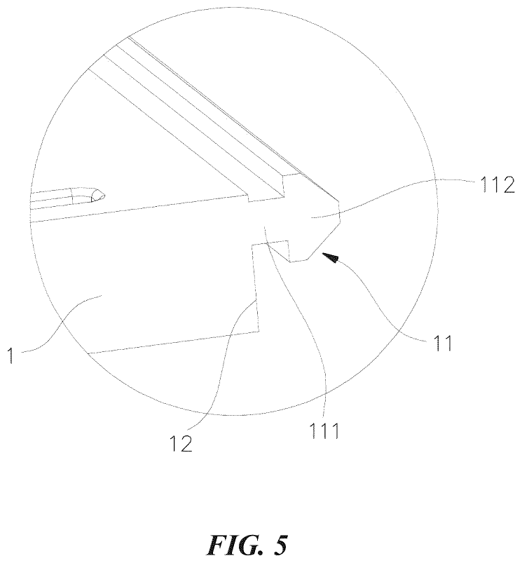

The present subject matter pertains to improved approaches for a screw-free and highly stable coupling structure between adjacent boards. Embodiments of the present subject matter are discussed below with reference to FIGS. 1-14.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

### Embodiment I

As shown in FIGS. 1 to 7, the board coupling structure of this embodiment can comprise a first board 1 and a second board 2 that can be inserted and interlocked into each other. The first board 1 and the second board 2 can be rectangle or square boards. When they are coupled, the first board 1 and the second board 2 can be perpendicular to each other. According to some embodiments, the first board 1 and the second board 2 can be respectively formed with at least one strip-shaped rib 11 and at least one strip-shaped groove 21 that can be inserted or plug-in into each other, so that the first board 1 and the second board 2 can only move in the insertion direction. The strip-shaped rib 11 of this embodiment can be disposed on one of the circumferential side surfaces 12 of the first board 1, whereas the strip-shaped groove 21 can be disposed on the inner side wall of the second board 2 and near an edge of the second board (2) along the length direction of the edge. According to some embodiments, the shape of the strip-shaped groove 21 can be adapted to the strip rib 11, with one end of the strip groove 21 forming an opening, and the other end being closed. As such, it can facilitate the insertion of the first board 1 and the second board 2 to form the coupling structure.

In this embodiment, the strip-shaped rib 11 can have a constricted portion 111 and a clamping portion 112. The circumferential side surface 12 of the first board 1 can extend outward to form a constricted portion 111, and the constricted portion 111 and the circumferential side surface 12 can be perpendicular to each other. The constricted portion 111 can continue to extend outward to form a clamping portion 112. The inner surface of the clamping portion 112 and the constricted portion 111 can be perpendicular to each other, and the clamping portion 112 can gradually become smaller from the inside to the outside.

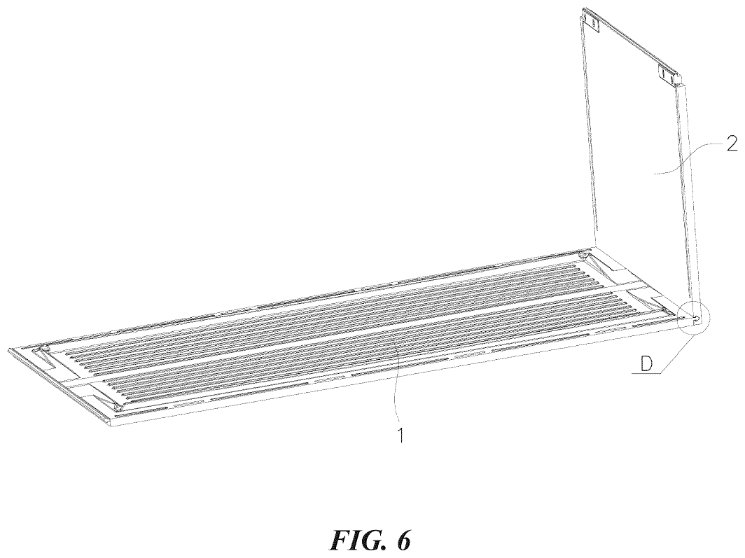

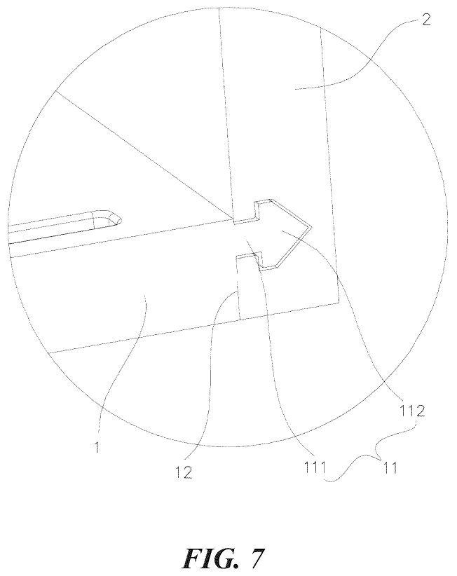

According to some embodiments, the clamping portion 112 can adopt various different shapes. For example, the cross-section of the clamping portion of this embodiment can be tapered. As shown in FIGS. 1 to 5, the tapered head is flat, which is a flat head structure. As shown in FIGS. 6 and 7, the tapered head is pointed, which is a pointed structure.

As the clamping part 112 adopts a tapered structure, the contact area between the strip-shaped rib 11 and the strip-shaped groove 21 of the present subject matter is larger than the conventional T-shaped groove structure. As such, the increased contact area can improve the stability of the coupling structure. Furthermore, it can also be beneficial to improve the waterproof performance of the two connected boards.

In this embodiment, the first board 1 can be the bottom board of the cabinet, and the second board 2 can be the side board of the cabinet. When interlocking with each other, the first board 1 can be horizontally placed, and then the second board 2 can be placed in a vertical position. A user can backwardly insert the stripe-shaped rib 11 from the open end of the stripe-shaped groove 21 until the rear end of the stripe-shaped rib 11 and the closed end of the stripe-shaped groove 21 abut, thereby completing the coupling of the first board 1 and the second board 2.

According to some embodiments, the board coupling structure can also be applied to the connection or joint between other adjacent boards of the cabinet. For example, the first board 1 can be the right side board of the cabinet and the second board 2 can be the front side board of the cabinet, which can be interlocked with each other. By eliminating the need of any connection accessories, the present coupling structure can be convenient and quick. Correspondingly, the disassembly can be convenient as the coupling structure is screw-free. In addition, the coupling structure can be adopted between other boards or panels, such as the left side board and the front side board, the left side board and the rear side board.

### Embodiment II

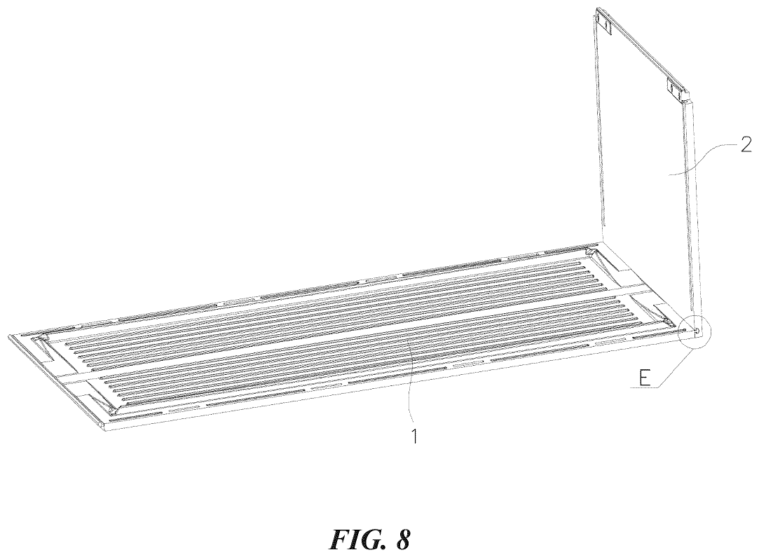

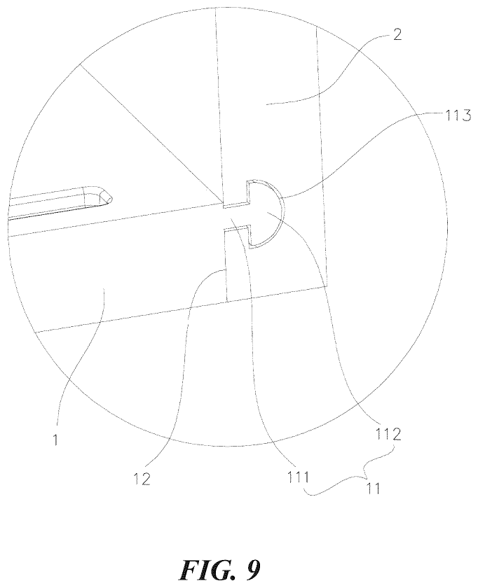

As shown in FIGS. 8 and 9, in this embodiment, the outer side surface of the clamping portion 112 can be an arc-shaped surface 113. As the remaining structure can be substantially the same as that of Embodiment I, Embodiment II is not further described in detail.

### Embodiment III

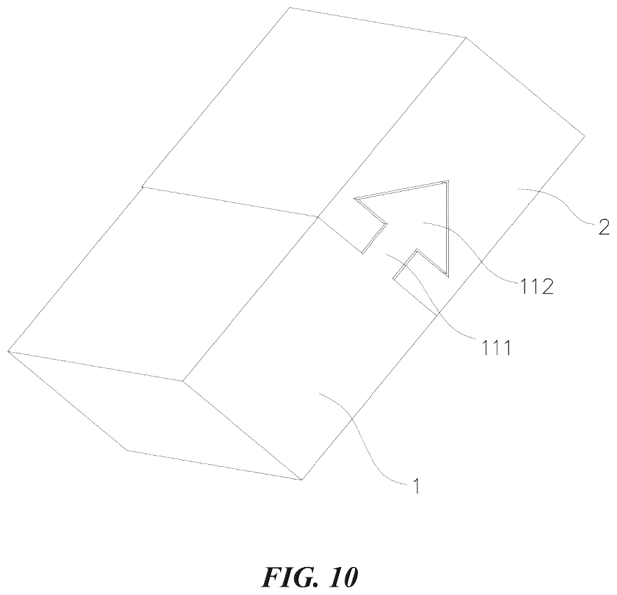

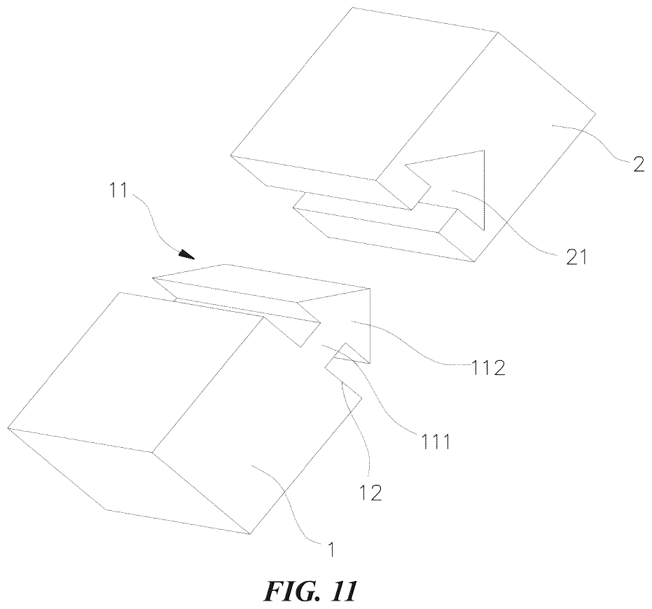

As shown in FIG. 10 and FIG. 11, the cross-section of the clamping portion 112 of this embodiment can be triangular. As the remaining structure can be substantially the same as that of Embodiment I, Embodiment III is not further described in detail.

### Embodiment IV

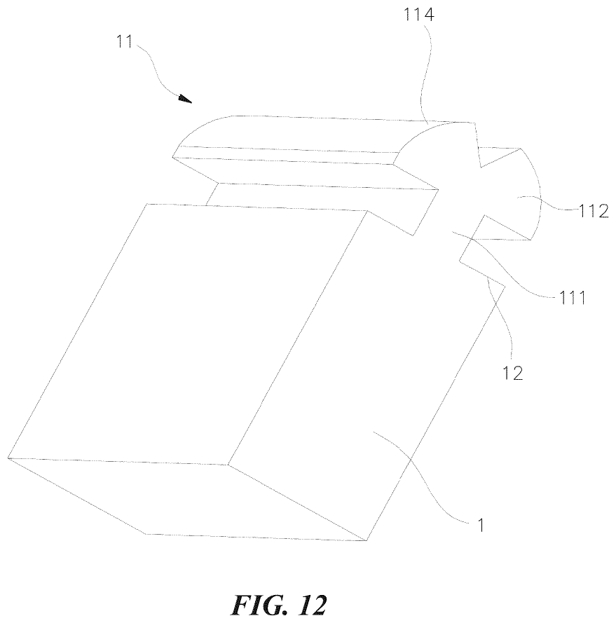

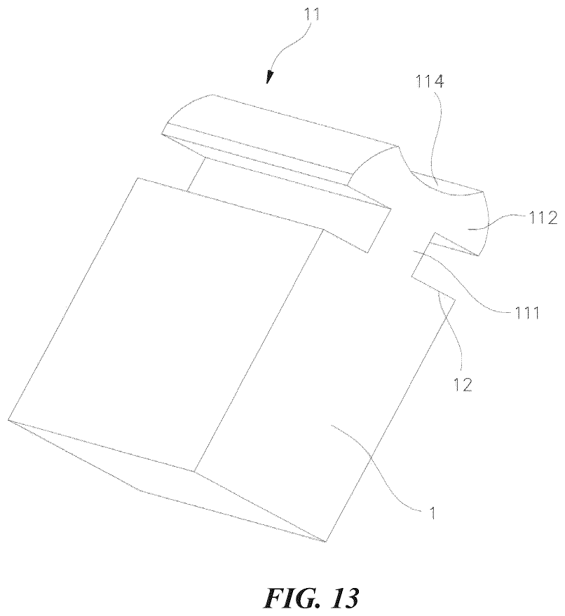

As shown in FIGS. 12 to 13, the outer side surface of the clamping portion 112 of the present embodiment can be a concave-convex surface 114. Specifically, the concave-convex surface 114 can adopt a structure in which both sides are convex and the middle is concave. After adopting the above-mentioned concave-convex structure, the contact area between the strip-shaped rib 11 and the strip-shaped groove 21 can also be increased. Similarly, on the one hand, the biting degree can be improved so that the coupling structure can be more stable and reliable. On the other hand, with the increased contact area, it is also beneficial to improve the waterproof performance of the connected boards.

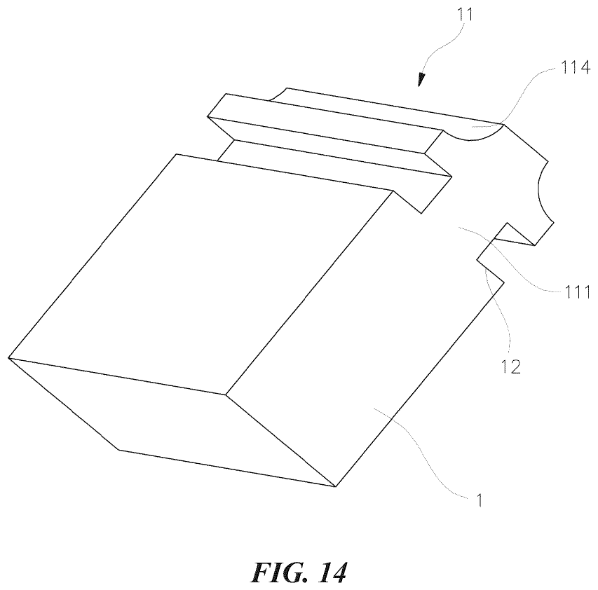

As shown in FIG. 14, the concave-convex surface 114 of the outer side surface of the clamping portion 112 of this embodiment can have a structure with a convex in the middle and a concave on both sides, similar to the description above.

The above are only the preferred embodiments of the present subject matter. It should be pointed out that for those of ordinary skill in the art, without departing from the principle of the present subject matter, various modifications or improvements can be made to the present subject matter, such as in other applications. For example, the first board and the second board may not be perpendicular to each other, and the specific shape of the clamping portion is not limited to the disclosed shapes, and these are all considered to be within the protection scope of the present subject matter.

It is to be understood that even though numerous characteristics and advantages of various embodiments of the present subject matter have been set forth in the foregoing description, together with details of the structure and function of various embodiments of the subject matter, this disclosure is illustrative only. In some cases, certain subassemblies are only described in detail with one such embodiment. Nevertheless, it is recognized and intended that such subassemblies may be used in other embodiments of the subject matter. Practitioners skilled in the art will recognize many modifications and variations. Changes may be made in detail, especially matters of structure and management of parts within the principles of the embodiments of the present subject matter to the full extent indicated by the broad general meaning of the terms in which the appended claims are expressed.

Having disclosed exemplary embodiments and the best mode, modifications and variations may be made to the disclosed embodiments while remaining within the scope of the embodiments of the subject matter as defined by the following claims.

What is claimed is:

1. A board coupling structure for plastic boards, comprising:
a first board (1) and a second board (2) each being respectively formed with a strip-shaped rib (11) and a strip-shaped groove (21) that can be inserted into each other, the first board (1) and the second board (2) being only movable relative to each other in the insertion direction,
wherein the strip-shaped rib (11) further comprises a constricted portion (111) formed by a circumferential side (12) of the first board (1) and a clamping portion (112) that extends from the constricted portion (111), wherein the constricted portion (111) is narrower than the clamping portion (112) in size, wherein the constricted portion (111) is perpendicular to the inner surface of the clamping portion (112) and wherein the outer surface of the clamping portion (112) is an arc surface (113), and
wherein the strip-shaped groove (21) is provided in the inner side wall of the second board (2), and the shape of the strip-shaped groove (21) matches the shape of the strip-shaped rib (11).

2. The board coupling structure of claim 1, wherein one end of the strip-shaped groove (21) is open and the other end of the strip-shaped groove (21) is closed.

3. The board coupling structure of claim 1, wherein the strip-shaped groove (21) is disposed near an edge of the second board (2) and is disposed along the length direction of the edge.

4. The board coupling structure of claim 1, wherein the first board (1) and the second board (2) are perpendicular to each other when they are coupled.

5. The board coupling structure of claim 1, wherein the constricted portion (111) and the circumferential side (12) are perpendicular to each other.

6. The board coupling structure of claim 1, wherein the arc surface (113) of the clamping portion (112) further comprises a V-shaped groove located in the center of the arc surface (113).

7. The board coupling structure of claim 1, wherein the arc surface (113) of the clamping portion (112) further comprises a concave groove located in the center of the arc surface (113).

8. The board coupling structure of claim 1, wherein the arc surface (113) of the clamping portion (112) further comprises two concave grooves located in the opposing two sides of the arc surface (113).

9. A plastic box having a board coupling structure for plastic boards, the board coupling structure comprising:
a first board (1) and a second board (2) each being respectively formed with a strip-shaped rib (11) and a strip-shaped groove (21) that can be inserted into each other, the first board (1) and the second board (2) being only movable relative to each other in the insertion direction,
wherein the strip-shaped rib (11) further comprises a constricted portion (111) formed by a circumferential side (12) of the first board (1) and a clamping portion (112) that extends from the constricted portion (111), wherein the constricted portion (111) is narrower than the clamping portion (112) in size, wherein the constricted portion (111) is perpendicular to the inner surface of the clamping portion (112) and wherein the outer surface of the clamping portion (112) is an arc surface (113), and
wherein the strip-shaped groove (21) is provided in the inner side wall of the second board (2), and the shape of the strip-shaped groove (21) matches the shape of the strip-shaped rib (11).

10. The plastic box of claim 9, wherein one end of the strip-shaped groove (21) is open and the other end of the strip-shaped groove (21) is closed.

11. The plastic box of claim 9, wherein the strip-shaped groove (21) is disposed near an edge of the second board (2) and is disposed along the length direction of the edge.

12. The plastic box of claim 9, wherein the first board (1) and the second board (2) are perpendicular to each other when they are coupled.

13. The plastic box of claim 9, wherein the constricted portion (111) and the circumferential side (12) are perpendicular to each other.

14. The plastic box of claim 9, wherein the arc surface (113) of the clamping portion (112) further comprises a V-shaped groove located in the center of the arc surface (113).

15. The plastic box of claim 9, wherein the arc surface (113) of the clamping portion (112) further comprises a concave groove located in the center of the arc surface (113).

16. The plastic box of claim 9, wherein the arc surface (113) of the clamping portion (112) further comprises two concave grooves located in the opposing two sides of the arc surface (113).
